(19) United States
(12) Patent Application Publication
(10) Pub. No.: US 2019/0036153 A1
(43) Pub. Date: Jan. 31, 2019

(54) NONAQUEOUS ELECTROLYTE SECONDARY BATTERY

(71) Applicant: Sumitomo Chemical Company, Limited, Tokyo (JP)

(72) Inventors: Ichiro ARISE, Osaka-shi, Osaka (JP); Chikara MURAKAMI, Osaka-shi, Osaka (JP)

(21) Appl. No.: 16/048,467

(22) Filed: Jul. 30, 2018

(30) Foreign Application Priority Data
Jul. 31, 2017 (JP) 2017-148557

(51) Int. Cl. H01M 10/0525; H01M 4/485; H01M 4/587; H01M 2/16

(52) U.S. Cl. CPC H01M 10/0525; H01M 2/16; H01M 4/587; H01M 4/485

(57) ABSTRACT

As a nonaqueous electrolyte secondary battery having an excellent charge capacity characteristic at measurement of an initial high-rate characteristic, provided is a nonaqueous electrolyte secondary battery including: a nonaqueous electrolyte secondary battery separator having ion permeability barrier energy of 300 J/mol/μm to 900 J/mol/μm per unit film thickness; a positive electrode plate having a capacitance of not less than 1 nF and not more than 1000 nF per measurement area of 900 mm²; and a negative electrode plate having a capacitance of not less than 4 nF and not more than 8500 nF per measurement area of 900 mm².

This Nonprovisional application claims priority under 35 U.S.C. § 119 on Patent Application No. 2017-148557 filed in Japan on Jul. 31, 2017, the entire contents of which are hereby incorporated by reference.

### TECHNICAL FIELD

The present invention relates to a nonaqueous electrolyte secondary battery.

### BACKGROUND ART

Nonaqueous electrolyte secondary batteries, particularly lithium-ion secondary batteries, have a high energy density, and are therefore in wide use as batteries for personal computers, mobile telephones, portable information terminals, and the like. Such nonaqueous electrolyte secondary batteries have recently been developed as on-vehicle batteries.

Safety of a nonaqueous electrolyte secondary battery, typified by a lithium-ion secondary battery, is typically ensured by imparting, to the nonaqueous electrolyte secondary battery, a shutdown function, that is, a function of, in a case where abnormal heat generation occurs, preventing further heat generation by precluding passage of ions between a positive electrode and a negative electrode with use of a separator made of a material which melts in a case where heat generation occurs.

As a nonaqueous electrolyte secondary battery having such a shutdown function, a nonaqueous electrolyte secondary battery has been suggested which, for example, includes a separator that is obtained by forming, on a porous base material, an active layer (coating layer) made of a mixture of inorganic fine particles and a binder polymer (Patent Literatures 1 to 3). Furthermore, a nonaqueous electrolyte secondary battery has been also suggested which includes an electrode for a lithium-ion secondary battery on which electrode a porous film that is made of inorganic fine particles and a binding agent (resin) and that can function as a separator is formed (Patent Literature 4).

### CITATION LIST

### Patent Literature

[Patent Literature 1]

Japanese Translation of PCT International Application, Tokuhyo, No. 2008-503049

[Patent Literature 2]

Japanese Patent No. 5460962

[Patent Literature 3]

Japanese Patent No. 5655088

[Patent Literature 4]

Japanese Patent No. 5569515

### SUMMARY OF INVENTION

### Technical Problem

However, a conventional nonaqueous electrolyte secondary battery as described above has room for improvement, in view of a charge capacity at measurement of an initial high-rate characteristic. That is, there has been a demand that a nonaqueous electrolyte secondary battery have an improved charge capacity characteristic at measurement of an initial high-rate characteristic.

### Solution to Problem

The present invention encompasses a nonaqueous electrolyte secondary battery as described below.

[1] A nonaqueous electrolyte secondary battery including:

a nonaqueous electrolyte secondary battery separator having ion permeability barrier energy of not less than 300 J/mol/μm and not more than 900 J/mol/μm per unit film thickness;

a positive electrode plate having a capacitance of not less than 1 nF and not more than 1000 nF per measurement area of 900 mm²; and

a negative electrode plate having a capacitance of not less than 4 nF and not more than 8500 nF per measurement area of 900 mm².

[2] The nonaqueous electrolyte secondary battery as described in [1], wherein the positive electrode plate contains a transition metal oxide.
[3] The nonaqueous electrolyte secondary battery as described in [1] or [2], wherein the negative electrode plate contains graphite.

### Advantageous Effects of Invention

A nonaqueous electrolyte secondary battery in accordance with an embodiment of the present invention has an excellent charge capacity characteristic at measurement of an initial high-rate characteristic.

### BRIEF DESCRIPTION OF DRAWINGS

FIG. 1 is a view schematically illustrating a measurement target electrode whose capacitance was to be measured in Examples of the present application.

FIG. 2 is a view schematically illustrating a probe electrode which was used for measurement of the capacitance in Examples of the present application.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. The present invention also encompasses, in its technical scope, any embodiment derived by combining technical means disclosed in differing embodiments. Note that a numerical expression “A to B” herein means “not less than A and not more than B” unless otherwise stated.

### Embodiment 1: Nonaqueous Electrolyte Secondary Battery

A nonaqueous electrolyte secondary battery in accordance with Embodiment 1 of the present invention includes: a separator for a nonaqueous electrolyte secondary battery (hereinafter referred to as a “nonaqueous electrolyte secondary battery separator”) (later described); a positive electrode plate (later described); and a negative electrode plate (later described). Members, each constituting the nonaqueous electrolyte secondary battery in accordance with an embodiment of the present invention, and the like will be described below in detail.

[Nonaqueous Electrolyte Secondary Battery Separator]

The nonaqueous electrolyte secondary battery separator in accordance with an embodiment of the present invention has therein many pores, connected to one another, so that a gas and/or a liquid can pass through the nonaqueous electrolyte secondary battery separator from one side to the other side. The nonaqueous electrolyte secondary battery separator typically includes a polyolefin porous film, and is preferably constituted by a polyolefin porous film. Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, with respect to the whole of materials of which the porous film is made. The polyolefin porous film can be a base material of the nonaqueous electrolyte secondary battery separator in accordance with an embodiment of the present invention.

The polyolefin-based resin more preferably contains a high molecular weight component having a weight-average molecular weight of 3×10⁵ to 15×10⁶. In particular, the polyolefin-based resin more preferably contains a high molecular weight component having a weight-average molecular weight of not less than 1,000,000, because the nonaqueous electrolyte secondary battery separator including the polyolefin porous film has higher strength.

Examples of the polyolefin-based resin which is a main component of the polyolefin porous film include, but are not particularly limited to, homopolymers (for example, polyethylene, polypropylene, and polybutene) and copolymers (for example, ethylene-propylene copolymer) each of which homopolymers and copolymers is a thermoplastic resin and is produced through polymerization of a monomer(s) such as ethylene, propylene, 1-butene, 4-methyl-1-pentene, and/or 1-hexene.

The polyolefin porous film can be a layer containing any one of these polyolefin-based resins solely or can be alternatively a layer containing two or more of these polyolefin-based resins. Of these polyolefin-based resins, the polyolefin porous film preferably contains polyethylene because the polyolefin porous film containing polyethylene makes it possible to prevent (shut down) a flow of an excessively large electric current at a lower temperature. In particular, the polyolefin porous film more preferably contains high molecular weight polyethylene which contains ethylene as a main component. Note that the polyolefin porous film can contain a component other than polyolefin, provided that the component does not impair a function of the polyolefin porous film.

Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Of these polyethylenes, ultra-high molecular weight polyethylene having a weight-average molecular weight of not less than 1,000,000 is still more preferable, and ultra-high molecular weight polyethylene which contains a high molecular weight component having a weight-average molecular weight of 5×10⁵ to 15×10⁶ is even more preferable.

A film thickness of the polyolefin porous film is not particularly limited, but is preferably 4 μm to 40 μm, and more preferably 5 μm to 20 μm. The film thickness of the polyolefin porous film is preferably not less than 4 μm, because the polyolefin porous film having such a film thickness makes it possible to sufficiently prevent an internal short circuit of the nonaqueous electrolyte secondary battery. On the other hand, the film thickness of the polyolefin porous film is preferably not more than 40 μm, because the polyolefin porous film having such a film thickness makes it possible to prevent an increase in size of the nonaqueous electrolyte secondary battery.

The polyolefin porous film typically has a weight per unit area of preferably 4 g/m² to 20 g/m², and more preferably 5 g/m² to 12 g/m² so that the nonaqueous electrolyte secondary battery can have a higher weight energy density and a higher volume energy density.

The polyolefin porous film has an air permeability of preferably 30 sec/100 mL to 500 sec/100 mL, and more preferably 50 sec/100 mL to 300 sec/100 mL, in terms of Gurley values, because the polyolefin porous film having such an air permeability exhibits sufficient ion permeability.

The polyolefin porous film has a porosity of preferably 20% by volume to 80% by volume, and more preferably 30% by volume to 75% by volume so that the polyolefin porous film can (i) retain an electrolyte in a larger amount and (ii) obtain a function of more absolutely preventing (shutting down) a flow of an excessively large electric current.

Pores in the polyolefin porous film each have a pore diameter of preferably not more than 0.3 μm, and more preferably not more than 0.14 μm, in view of sufficient ion permeability and of prevention of entry of particles, constituting an electrode, into the pores in the polyolefin porous film.

(Ion Permeability Barrier Energy Per Unit Film Thickness)

In the present invention, ion permeability barrier energy per unit film thickness of the nonaqueous electrolyte secondary battery separator is represented by a value obtained by dividing, by a film thickness of the nonaqueous electrolyte secondary battery separator, activation energy (barrier energy) which ions (for example, Lit), which are charge carriers, consume while passing through the nonaqueous electrolyte secondary battery separator in a case where the nonaqueous electrolyte secondary battery is operated. The ion permeability barrier energy per unit film thickness is an index indicative of how easily the ions pass through the nonaqueous electrolyte secondary battery separator.

In a case where the ion permeability barrier energy per unit film thickness is low, it is possible for the ions to easily pass through the nonaqueous electrolyte secondary battery separator. In other words, interaction between (i) the ions and (ii) a resin wall inside the nonaqueous electrolyte secondary battery separator is weak. In a case where the ion permeability barrier energy per unit film thickness is high, it is not possible for the ions to easily pass through the nonaqueous electrolyte secondary battery separator. In other words, the interaction between (i) the ions and (ii) the resin wall inside the nonaqueous electrolyte secondary battery separator is strong.

In a case where the ion permeability barrier energy per unit film thickness is excessively low, the ion permeability barrier energy of the nonaqueous electrolyte secondary battery separator having a typically employed film thickness becomes excessively low.

It is considered that this causes (i) an excessive increase in speed at which the ions pass through the nonaqueous electrolyte secondary battery separator, (ii) an excessive amount of the electrolyte to flow from an electrode to the nonaqueous electrolyte secondary battery separator, (iii) the ions to be non-existent in the electrode, and, as a result, (iv) a deterioration of a charge capacity characteristic at measurement of an initial high-rate characteristic.

Note, here, that the “charge capacity characteristic at measurement of an initial high-rate characteristic” is represented by a charge capacity. Specifically, a nonaqueous electrolyte secondary battery which has been subjected to initial charge-discharge cycles is subjected to charge-discharge cycles under the following conditions: (i) a temperature is set to 55° C.; (ii) a voltage is set to a range of 2.7 V to 4.2 V; (iii) CC-CV charge is carried out at a rate of 1 C (final rate: 0.02 C); and (iv) CC discharge is carried out in such a manner that a rate is first set to 0.2 C and then changed to 1 C, 5 C, and 10 C in this order every 3 charge-discharge cycles. A charge capacity at 1 C charge in the third one of 3 charge-discharge cycles in which 10 C discharge is carried out indicates the “charge capacity characteristic at measurement of an initial high-rate characteristic.”

Moreover, in a case where the ion permeability barrier energy per unit film thickness is excessively low, it is necessary to excessively increase the film thickness in order to cause the ion permeability barrier energy of the nonaqueous electrolyte secondary battery separator to fall within a specific range. It is considered that, in this case, since a movement distance of the ions becomes longer and the ions are accordingly prevented from moving inside the nonaqueous electrolyte secondary battery, the charge capacity characteristic at the measurement of the initial high-rate characteristic is deteriorated.

Therefore, in view of prevention of a deterioration of the charge capacity characteristic at the measurement of the initial high-rate characteristic, the ion permeability barrier energy per unit film thickness is not less than 300 J/mol/μm, preferably not less than 320 J/mol/μm, and more preferably not less than 350 J/mol/μm.

Meanwhile, in a case where the ion permeability barrier energy per unit film thickness is excessively high, the ion permeability barrier energy of the nonaqueous electrolyte secondary battery separator having a typically employed film thickness becomes excessively high.

It is considered that this causes (i) an excessive decrease in ion permeability of the nonaqueous electrolyte secondary battery separator, (ii) the ions to be prevented from moving inside the nonaqueous electrolyte secondary battery, and, as a result, (iii) a deterioration of the charge capacity characteristic at the measurement of the initial high-rate characteristic.

Moreover, in a case where the ion permeability barrier energy per unit film thickness is excessively high, it is necessary to excessively reduce the film thickness in order to cause the ion permeability barrier energy of the nonaqueous electrolyte secondary battery separator to fall within the specific range. It is considered that, in this case, since the nonaqueous electrolyte secondary battery separator is excessively thin, is accordingly easily broken, and easily causes a short circuit, the charge capacity characteristic at the measurement of the initial high-rate characteristic may be deteriorated.

Therefore, in view of prevention of a deterioration of the charge capacity characteristic at the measurement of the initial high-rate characteristic, the ion permeability barrier energy per unit film thickness is not more than 900 J/mol/μm, preferably not more than 800 J/mol/μm, and more preferably not more than 780 J/mol/μm.

(Method for Measuring Ion Permeability Barrier Energy Per Unit Film Thickness)

The ion permeability barrier energy per unit film thickness of the nonaqueous electrolyte secondary battery separator in accordance with an embodiment of the present invention is calculated by the following method.

First, the nonaqueous electrolyte secondary battery separator is cut into a disc-shaped piece having a diameter of 17 mm. The disc-shaped piece is sandwiched between two SUS plates each having a thickness of 0.5 mm and a diameter of 15.5 mm. The electrolyte is injected into a cell thus obtained so as to prepare a coin cell (CR2032 type). As the electrolyte, a solution is used which is obtained by dissolving LiPF₆ in a mixed solvent, in which ethylene carbonate (EC), ethyl methyl carbonate (EMC), and diethyl carbonate (DEC) are mixed at a volume ratio of 3:5:2, so that a concentration of the LiPF₆ becomes 1 mol/L.

Next, the coin cell thus prepared is placed in a thermostatic bath in which a temperature is set to a given temperature, and a Nyquist plot is obtained with use of an alternating current impedance apparatus (FRA 1255B) and CellTest System (1470E), each manufactured by Solartron, while a frequency is set to 1 MHz to 0.1 Hz and an amplitude is set to 10 mV. A solution resistance r₀ of the nonaqueous electrolyte secondary battery separator at the given temperature is determined from a value of an X intercept of the Nyquist plot. With use of obtained values, the ion permeability barrier energy is calculated by the following expressions (1) and (2). The temperature of the thermostatic bath is set to 50° C., 25° C., 5° C., and −10° C.

Here, the ion permeability barrier energy is represented by the following expression (1).

k=1/r₀=Aexp(−Ea/RT) (1)

Ea: ion permeability barrier energy (J/mol)
k: a reaction constant
r₀: a solution resistance (Ω)
A: a frequency factor
R: a gas constant=8.314 J/mol/K
T: a temperature of a thermostatic bath (K)

In a case where natural logarithms of both sides of the expression (1) are taken, the following expression (2) is obtained. On the basis of the expression (2), −Ea/R is determined which indicates a slope of a straight line obtained by (i) plotting ln(1/r₀) with respect to a reciprocal (1/T) of each temperature and (ii) applying a least squares method to a plot thus obtained, and then Ea is calculated by multiplying a value of −Ea/R by a gas constant R. Subsequently, Ea thus calculated is divided by the film thickness of the nonaqueous electrolyte secondary battery separator. In this way, the ion permeability barrier energy per unit film thickness is calculated.

ln(k)=ln(1/r₀)=ln A−Ea/RT (2)

Note that a value of the frequency factor A is a unique value which does not vary depending on a change in temperature and which is determined depending on an aspect, an amount of electric charges, a size, and the like of the ions that pass through the nonaqueous electrolyte secondary battery separator. The value of the frequency factor A is a value of ln(1/r₀) in a case where (1/T)=0, and is experimentally calculated from the plot.

The film thickness of the nonaqueous electrolyte secondary battery separator is not particularly limited, but is preferably 4 μm to 40 μm, and more preferably 5 μm to 20 μm.

The film thickness of the nonaqueous electrolyte secondary battery separator is preferably not less than 4 μm, because the nonaqueous electrolyte secondary battery separator having such a film thickness makes it possible to sufficiently prevent an internal short circuit of the nonaqueous electrolyte secondary battery.

On the other hand, the film thickness of the nonaqueous electrolyte secondary battery separator is preferably not more than 40 μm, because the nonaqueous electrolyte secondary battery separator having such a film thickness makes it possible to prevent an increase in size of the nonaqueous electrolyte secondary battery.

The nonaqueous electrolyte secondary battery separator typically has a weight per unit area of preferably 4 g/m² to 20 g/m², and more preferably 5 g/m² to 12 g/m² so that the nonaqueous electrolyte secondary battery can have a higher weight energy density and a higher volume energy density.

The nonaqueous electrolyte secondary battery separator has an air permeability of preferably 30 sec/100 mL to 500 sec/100 mL, and more preferably 50 sec/100 mL to 300 sec/100 mL, in terms of Gurley values, because the nonaqueous electrolyte secondary battery separator having such an air permeability exhibits sufficient ion permeability.

The nonaqueous electrolyte secondary battery separator has a porosity of preferably 20% by volume to 80% by volume, and more preferably 30% by volume to 75% by volume so that the nonaqueous electrolyte secondary battery separator can (i) retain the electrolyte in a larger amount and (ii) obtain a function of absolutely preventing (shutting down) a flow of an excessively large electric current at a lower temperature.

The pores in the nonaqueous electrolyte secondary battery separator each have a pore diameter of preferably not more than 0.3 μm, and more preferably not more than 0.14 μm, in view of sufficient ion permeability and of prevention of entry of particles, constituting an electrode, into the pores in the nonaqueous electrolyte secondary battery separator.

The nonaqueous electrolyte secondary battery separator in accordance with an embodiment of the present invention can further include a heat-resistant layer, an adhesive layer, a protective layer, and/or the like as necessary, in addition to the polyolefin porous film.

[Method for Producing Polyolefin Porous Film]

Examples of a method for producing the polyolefin porous film include, but are not particularly limited to, a method in which (i) the polyolefin-based resin, a petroleum resin, and a plasticizer are kneaded and then extruded to obtain a sheet-shaped polyolefin resin composition, (ii) the sheet-shaped polyolefin resin composition thus obtained is stretched, (iii) part or all of the plasticizer is removed with use of an appropriate solvent, and (iv) a resultant polyolefin resin composition is dried and heat-fixed.

Specifically, the method can be a method including the following steps of:

(A) melt-kneading a polyolefin-based resin and a petroleum resin in a kneader to obtain a melted mixture;
(B) kneading the melted mixture thus obtained and a plasticizer to obtain a polyolefin resin composition;
(C) extruding, through a T-die of an extruder, the polyolefin resin composition thus obtained, and shaping the polyolefin resin composition into a sheet while cooling the polyolefin resin composition, to obtain a sheet-shaped polyolefin resin composition;
(D) stretching the sheet-shaped polyolefin resin composition thus obtained;
(E) cleaning, with use of a cleaning liquid, a resultant stretched polyolefin resin composition; and
(F) drying and heat-fixing a resultant cleaned polyolefin resin composition to obtain a polyolefin porous film.

In the step (A), the polyolefin-based resin is used in an amount of preferably 6% by weight to 45% by weight, and more preferably 9% by weight to 36% by weight, with respect to 100% by weight of the polyolefin resin composition to be obtained.

Examples of the petroleum resin include: (i) aliphatic hydrocarbon resins each obtained through polymerization of a C5 petroleum fraction, such as isoprene, pentene, and pentadiene, which serves as a main raw material; (ii) aromatic hydrocarbon resins each obtained through polymerization of a C9 petroleum fraction, such as indene, vinyltoluene, and methyl styrene, which serves as a main raw material; (iii) copolymer resins of the resins (i) and (ii); (iv) alicyclic saturated hydrocarbon resins obtained through hydrogenation of the resins (i) to (iii); and (v) mixtures of the resins (i) to (iv). The petroleum resin is preferably an alicyclic saturated hydrocarbon resin. The petroleum resin has a characteristic that the petroleum resin is easily oxidized because the petroleum resin has, in its structure, many unsaturated bonds and many tertiary carbon atoms each of which unsaturated bonds and tertiary carbon atoms easily produces a radical.

By mixing the petroleum resin into the polyolefin resin composition, it is possible to adjust interaction between (i) the charge carriers and (ii) a resin wall inside the polyolefin porous film to be obtained. In other words, it is possible to suitably adjust the ion permeability barrier energy of the nonaqueous electrolyte secondary battery separator.

By mixing the polyolefin-based resin with the petroleum resin which is oxidized more easily than the polyolefin-based resin, it is possible to appropriately oxidize the resin wall inside the polyolefin porous film to be obtained. That is, in a case where the petroleum resin is added to the polyolefin-based resin, the nonaqueous electrolyte secondary battery separator to be obtained has great ion permeability barrier energy, as compared with a case where the petroleum resin is not added to the polyolefin-based resin.

The petroleum resin preferably has a softening point of 90° C. to 125° C. The petroleum resin is used in an amount of preferably 0.5% by weight to 40% by weight, and more preferably 1% by weight to 30% by weight, with respect to 100% by weight of the polyolefin resin composition to be obtained.

Examples of the plasticizer include: phthalate esters such as dioctyl phthalate; unsaturated higher alcohols such as oleyl alcohol; saturated higher alcohols such as paraffin wax and stearyl alcohol; and liquid paraffin.

In the step (B), a temperature inside the kneader at a time when the plasticizer is introduced into the kneader is preferably not lower than 135° C. and not higher than 200° C., and more preferably not lower than 140° C. and not higher than 170° C.

By controlling the temperature inside the kneader to fall within the above range, it is possible to add the plasticizer to the melted mixture of the polyolefin-based resin and the petroleum resin while the polyolefin-based resin and the petroleum resin are suitably mixed together. This makes it possible to more suitably obtain an effect of mixing the polyolefin-based resin with the petroleum resin.

For example, in a case where the temperature inside the kneader at a time when the plasticizer is added to the melted mixture of the polyolefin-based resin and the petroleum resin is excessively low, it is not possible to uniformly mix the polyolefin-based resin with the petroleum resin and, accordingly, may not be possible to appropriately oxidize the resin wall inside the polyolefin porous film. In a case where the temperature is excessively high (for example, not lower than 200° C.), these resins may be deteriorated by heat.

In the step (D), the sheet-shaped polyolefin resin composition can be stretched merely in a machine direction (MD) or alternatively merely in a transverse direction (TD) or alternatively in both of the MD and the TD. Examples of a method for stretching the sheet-shaped polyolefin resin composition in both of the MD and the TD include: a sequential two-way stretching method in which the sheet-shaped polyolefin resin composition is stretched in the MD and then stretched in the TD; and a simultaneous two-way stretching method in which the sheet-shaped polyolefin resin composition is simultaneously stretched in the MD and the TD.

The sheet-shaped polyolefin resin composition can be stretched by drawing the sheet-shaped polyolefin resin composition while holding its edges with use of chucks. Alternatively, the sheet-shaped polyolefin resin composition can be stretched by causing respective rotational speeds of rollers, each for transferring the sheet-shaped polyolefin composition, to be different from each other. Alternatively, the sheet-shaped polyolefin resin composition can be stretched by rolling the sheet-shaped polyolefin resin composition with use of a pair of rollers.

In the step (D), a stretch ratio at which the sheet-shaped polyolefin resin composition is stretched in the MD is preferably not less than 3.0 times and not more than 7.0 times, and more preferably not less than 4.5 times and not more than 6.5 times. A stretch ratio at which the sheet-shaped polyolefin resin composition, having been stretched in the MD, is further stretched in the TD is preferably not less than 3.0 times and not more than 7.0 times, and more preferably not less than 4.5 times and not more than 6.5 times.

A temperature at which the sheet-shaped polyolefin resin composition is stretched is preferably not higher than 130° C., and more preferably 110° C. to 120° C.

In the step (E), the cleaning liquid is not limited to any particular one, provided that the cleaning liquid is a solvent which allows removal of the plasticizer and the like. Examples of the cleaning liquid include: aliphatic hydrocarbons such as heptane, octane, nonane, and decane; and halogenated hydrocarbons such as methylene chloride, chloroform, dichloroethane, and 1,2-dichloropropane.

In the step (F), drying and heat fixing are carried out by heat-treating the cleaned polyolefin resin composition at a specific temperature. The drying and the heat fixing are usually carried out under atmospheric air with use of an air blowing dryer, a heating roller, or the like.

The drying and the heat fixing are carried out at a temperature of preferably not lower than 100° C. and not higher than 150° C., more preferably not lower than 110° C. and not higher than 140° C., and still more preferably not lower than 120° C. and not higher than 135° C. so that (a) a degree of oxidization of the resin wall inside the polyolefin porous film is further finely adjusted and (b) the interaction between (i) the charge carriers and (ii) the resin wall inside the polyolefin porous film is suitably controlled. Furthermore, the drying and the heat fixing are carried out for preferably not less than 1 minute and not more than 60 minutes, and more preferably not less than 1 minute and not more than 30 minutes.

[Laminated Body]

The nonaqueous electrolyte secondary battery separator included in the nonaqueous electrolyte secondary battery in accordance with an embodiment of the present invention can be arranged so as to include an insulating porous layer disposed on one surface or each of both surfaces of the polyolefin porous film which is included in the nonaqueous electrolyte secondary battery separator and which has been described in the above item [Nonaqueous electrolyte secondary battery separator]. In the following description, the nonaqueous electrolyte secondary battery separator thus arranged may be referred to as a “laminated body.” Furthermore, the nonaqueous electrolyte secondary battery separator described in the above item [Nonaqueous electrolyte secondary battery separator] may be referred to as a “separator 1.”

[Insulating Porous Layer]

The insulating porous layer is typically a resin layer containing a resin. The insulating porous layer is preferably a heat-resistant layer or an adhesive layer. The insulating porous layer (hereinafter, also referred to as simply a “porous layer”) preferably contains a resin that is insoluble in the electrolyte of the nonaqueous electrolyte secondary battery and that is electrochemically stable when the nonaqueous electrolyte secondary battery is in normal use.

The porous layer is disposed on one surface or each of both surfaces of the polyolefin porous film, as necessary, so as to constitute the laminated body. In a case where the porous layer is disposed on merely one surface of the polyolefin porous film, the porous layer is preferably disposed on that surface of the polyolefin porous film which surface faces the positive electrode plate, more preferably on that surface of the polyolefin porous film which surface comes into contact with the positive electrode plate, in the nonaqueous electrolyte secondary battery in accordance with an embodiment of the present invention.

Examples of the resin constituting the porous layer include polyolefins; (meth)acrylate-based resins; fluorine-containing resins; polyamide-based resins; polyimide-based resins; polyester-based resins; rubbers; resins each having a melting point or a glass transition temperature of not lower than 180° C.; and water-soluble polymers.

Of the above resins, polyolefins, polyester-based resins, acrylate-based resins, fluorine-containing resins, polyamide-based resins, and water-soluble polymers are preferable. Of the polyamide-based resins, wholly aromatic polyamides (aramid resins) are preferable. Of the polyester-based resins, polyarylates and liquid crystal polyesters are preferable.

The porous layer can contain fine particles. The term “fine particles” herein means organic fine particles or inorganic fine particles, generally referred to as a filler. Therefore, in a case where the porous layer contains fine particles, the above-described resin contained in the porous layer functions as a binder resin which binds (i) the fine particles together and (ii) the fine particles and the polyolefin porous film together. The fine particles are preferably insulating fine particles.

Examples of the organic fine particles contained in the porous layer include resin fine particles.

Specific examples of the inorganic fine particles contained in the porous layer include fillers each made of an inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. These inorganic fine particles are insulating fine particles. Of these fine particles, the porous layer can contain only one kind of fine particles or can alternatively contain two or more kinds of fine particles in combination.

Of the above fine particles, fine particles made of an inorganic matter are suitable. More preferable are fine particles made of an inorganic oxide such as silica, calcium oxide, magnesium oxide, titanium oxide, alumina, mica, zeolite, aluminum hydroxide, or boehmite. Still more preferable are fine particles made of at least one kind selected from the group consisting of silica, magnesium oxide, titanium oxide, aluminum hydroxide, boehmite, and alumina. Particularly preferable are fine particles made of alumina.

The porous layer contains the fine particles in an amount of preferably 1% by volume to 99% by volume, and more preferably 5% by volume to 95% by volume, with respect to 100% by volume of the porous layer. In a case where the amount of the fine particles falls within the above range, it is less likely that a void, which is formed when the fine particles come into contact with each other, is blocked by the resin or the like. This allows the porous layer to achieve sufficient ion permeability and an appropriate weight per unit area.

The porous layer can contain two or more kinds of fine particles in combination which two or more kinds differ from each other in particle or specific surface area.

The porous layer has a thickness of preferably 0.5 μm to 15 μm (per layer), and more preferably 2 μm to 10 μm (per layer).

In a case where the thickness of the porous layer is less than 0.5 μm (per layer), it may not be possible to sufficiently prevent an internal short circuit caused by breakage or the like of the nonaqueous electrolyte secondary battery. In addition, an amount of the electrolyte retained by the porous layer may be decreased. In contrast, in a case where the thickness of the porous layer is more than 15 μm (per layer), a battery characteristic, such as the charge capacity characteristic at the measurement of the initial high-rate characteristic, may be deteriorated.

The porous layer has a weight per unit area of preferably 1 g/m² to 20 g/m² (per layer), and more preferably 4 g/m² to 10 g/m² (per layer).

A volume of a porous layer constituent component per square meter of the porous layer is preferably 0.5 cm³ to 20 cm³ (per layer), more preferably 1 cm³ to 10 cm³ (per layer), and still more preferably 2 cm³ to 7 cm³ (per layer).

The porous layer has a porosity of preferably 20% by volume to 90% by volume, and more preferably 30% by volume to 80% by volume so that the porous layer can achieve sufficient ion permeability. Pores in the porous layer each have a pore diameter of preferably not more than 3 μm, and more preferably not more than 1 μm, in view of prevention of entry of particles, constituting an electrode, into the pores in the porous layer.

The laminated body in accordance with an embodiment of the present invention has a film thickness of preferably 5.5 μm to 45 μm, and more preferably 6 μm to 25 μm.

The laminated body in accordance with an embodiment of the present invention has an air permeability of preferably 30 sec/100 mL to 1000 sec/100 mL, and more preferably 50 sec/100 mL to 800 sec/100 mL, in terms of Gurley values.

The laminated body in accordance with an embodiment of the present invention can include, in addition to the polyolefin porous film and the insulating porous layer, a publicly known porous film (porous layer) such as a heat-resistant layer, an adhesive layer, and a protective layer as necessary, provided that the publicly known porous film does not prevent the object of the present invention from being attained.

The laminated body in accordance with an embodiment of the present invention has ion permeability barrier energy per unit film thickness which falls within a specific range that is identical to that of the ion permeability barrier energy per unit film thickness of the separator 1. This allows an improvement in the charge capacity characteristic at the measurement of the initial high-rate characteristic of the nonaqueous electrolyte secondary battery including the laminated body. The ion permeability barrier energy per unit film thickness of the laminated body can be controlled by, for example, adjusting, by the above-described method (that is, by mixing the petroleum resin into the polyolefin resin composition), the ion permeability barrier energy per unit film thickness of the separator 1 included in the laminated body.

[Method for Producing Laminated Body]

The laminated body in accordance with an embodiment of the present invention can be produced by, for example, a method in which (i) a coating solution (later described) is applied to a surface of the polyolefin porous film and then (ii) the coating solution is dried so that the porous layer is deposited.

Note that, before the coating solution is applied to the surface of the polyolefin porous film, the surface to which the coating solution is to be applied can be subjected to a hydrophilization treatment as necessary.

The coating solution used in a method for producing the laminated body in accordance with an embodiment of the present invention can be prepared typically by (i) dissolving, in a solvent, the resin that can be contained in the porous layer and (ii) dispersing, in the solvent, the fine particles that can be contained in the porous layer. Note, here, that the solvent in which the resin is to be dissolved also serves as a dispersion medium in which the fine particles are to be dispersed. Note, here, that the resin can be alternatively contained as an emulsion in the coating solution, instead of being dissolved in the solvent.

The solvent (dispersion medium) is not limited to any particular one, provided that (i) the solvent does not have an adverse effect on the polyolefin porous film, (ii) the solvent allows the resin to be uniformly and stably dissolved in the solvent, and (iii) the solvent allows the fine particles to be uniformly and stably dispersed in the solvent. Specific examples of the solvent (dispersion medium) include water and organic solvents. Each of these solvents can be used solely. Alternatively, two or more of these solvents can be used in combination.

The coating solution can be formed by any method, provided that it is possible for the coating solution to meet conditions, such as a resin solid content (resin concentration) and a fine particle amount, which are necessary to obtain a desired porous layer. Specific examples of a method for forming the coating solution include a mechanical stirring method, an ultrasonic dispersion method, a high-pressure dispersion method, and a media dispersion method. Note that the coating solution can contain, as a component other than the resin and the fine particles, an additive such as a disperser, a plasticizer, a surfactant, and a pH adjustor, provided that the additive does not prevent the object of the present invention from being attained. Note that the additive can be contained in an amount that does not prevent the object of the present invention from being attained.

A method for applying the coating solution to the polyolefin porous film, that is, a method for forming the porous layer on the surface of the polyolefin porous film is not limited to any particular one. Examples of the method for forming the porous layer include: a method in which the coating solution is applied directly to the surface of the polyolefin porous film and then the solvent (dispersion medium) is removed; a method in which (i) the coating solution is applied to an appropriate support, (ii) the solvent (dispersion medium) is removed so that the porous layer is formed, (iii) the porous layer is pressure-bonded to the polyolefin porous film, and then (iv) the support is peeled off; and a method in which (i) the coating solution is applied to an appropriate support, (ii) the polyolefin porous film is pressure-bonded to a surface of the support to which surface the coating solution is applied, (iii) the support is peeled off, and then (iv) the solvent (dispersion medium) is removed.

The coating solution can be applied to the polyolefin porous film or the support by a conventionally publicly known method. Specific examples of such a method include a gravure coater method, a dip coater method, a bar coater method, and a die coater method.

The solvent (dispersion medium) is generally removed by drying the coating solution. Note that the coating solution can be dried after the solvent (dispersion medium) contained in the coating solution is replaced with another solvent.

[Positive Electrode Plate, Negative Electrode Plate]

(Capacitance)

In the present invention, a value of a capacitance of the positive electrode plate is a value measured by a method for measuring a capacitance of an electrode plate (later described), that is, a value measured while an electrode for measurement (probe electrode, hereinafter referred to as a measurement electrode) is in contact with a surface of the positive electrode plate which surface is located on a positive electrode mix layer side. The capacitance of the positive electrode plate mainly indicates a polarization state of a positive electrode mix layer of the positive electrode plate.

In the present invention, a value of a capacitance of the negative electrode plate is a value measured by the method for measuring a capacitance of an electrode plate (later described), that is, a value measured while a measurement electrode is in contact with a surface of the negative electrode plate which surface is located on a negative electrode mix layer side. The capacitance of the negative electrode plate mainly indicates a polarization state of a negative electrode mix layer of the negative electrode plate.

In a case where the nonaqueous electrolyte secondary battery is charged, cations (for example, Li⁺ in a case of a lithium-ion secondary battery), which are charge carriers, are released from the positive electrode plate. The cations thus released pass through the nonaqueous electrolyte secondary battery separator, and are then taken into the negative electrode plate.

In a case where the cations are released from the positive electrode plate, the cations are solvated, by an electrolyte solvent, in the positive electrode plate and a place where the positive electrode plate and the nonaqueous electrolyte secondary battery separator are in contact with each other. In a case where the cations are taken into the negative electrode plate, the cations are desolvated in the negative electrode plate and a place where the negative electrode plate and the nonaqueous electrolyte secondary battery separator are in contact with each other.

A degree to which the cations are solvated is dependent on the polarization state of the positive electrode mix layer of the positive electrode plate. A degree to which the cations are desolvated is dependent on the polarization state of the negative electrode mix layer of the negative electrode plate.

By controlling the capacitance of each of the positive electrode plate and the negative electrode plate (hereinafter each also referred to an electrode plate) of the nonaqueous electrolyte secondary battery in accordance with an embodiment of the present invention to fall within a specific range, it is possible to promote solvation of the charge carriers in the positive electrode plate and the place where the positive electrode plate and the nonaqueous electrolyte secondary battery separator are in contact with each other. Furthermore, by controlling the capacitance to fall within the specific range, it is possible to promote desolvation of the charge carriers in the negative electrode plate and the place where the negative electrode plate and the nonaqueous electrolyte secondary battery separator are in contact with each other. As a result, it is possible to improve the charge capacity characteristic at the measurement of the initial high-rate characteristic.

In view of an improvement in the charge capacity characteristic at the measurement of the initial high-rate characteristic, the positive electrode plate of the nonaqueous electrolyte secondary battery in accordance with an embodiment of the present invention has a capacitance of not less than 1 nF, and preferably not less than 2 nF, per measurement area of 900 mm². Note that the capacitance can be not less than 3 nF per measurement area of 900 mm². For a similar reason, the positive electrode plate has a capacitance of not more than 1000 nF, preferably not more than 600 nF, and more preferably not more than 400 nF, per measurement area of 900 mm².

In a case where the positive electrode plate has a capacitance of less than 1 nF per measurement area of 900 mm², polarizability of the positive electrode plate is so low that the capacitance hardly contributes to the solvation. Therefore, according to the nonaqueous electrolyte secondary battery including such a positive electrode plate, it is not considered that the charge capacity characteristic at the measurement of the initial high-rate characteristic is sufficiently improved.

In a case where the positive electrode plate has a capacitance of more than 1000 nF per measurement area of 900 mm², the polarizability of the positive electrode plate is so high that compatibility between (i) inner walls of voids in the positive electrode plate and (ii) the cations (for example, Li⁺) becomes excessively high. This prevents movement (release) of the cations (for example, Li⁺) inside the positive electrode mix layer of the positive electrode plate. Therefore, according to the nonaqueous electrolyte secondary battery including such a positive electrode plate, it is considered that the charge capacity characteristic at the measurement of the initial high-rate characteristic is rather deteriorated.

In view of an improvement in the charge capacity characteristic at the measurement of the initial high-rate characteristic, the negative electrode plate of the nonaqueous electrolyte secondary battery in accordance with an embodiment of the present invention has a capacitance of not less than 4 nF per measurement area of 900 mm². Note that the capacitance can be not less than 100 nF, not less than 200 nF, or not less than 1000 nF, per measurement area of 900 mm². For a similar reason, the negative electrode plate has a capacitance of not more than 8500 nF, preferably not more than 3000 nF, and more preferably not more than 2600 nF, per measurement area of 900 mm².

In a case where the negative electrode plate has a capacitance of less than 4 nF per measurement area of 900 mm², polarizability of the negative electrode plate is so low that the capacitance hardly contributes to promotion of the desolvation. Therefore, according to the nonaqueous electrolyte secondary battery including such a negative electrode plate, it is not considered that the charge capacity characteristic at the measurement of the initial high-rate characteristic is sufficiently improved.

In a case where the negative electrode plate has a capacitance of more than 8500 nF per measurement area of 900 mm², the polarizability of the negative electrode plate is so high that the desolvation is excessively advanced. In so doing, the electrolyte solvent for the cations (for example, Li⁺) to move inside the negative electrode plate is desolvated, and compatibility between (i) inner walls of voids in the negative electrode plate and (ii) the cations (for example, Li⁺) which have been desolvated becomes excessively high. This prevents movement of the cations (for example, Li⁺) inside the negative electrode plate. Therefore, according to the nonaqueous electrolyte secondary battery including such a negative electrode plate, it is considered that the charge capacity characteristic at the measurement of the initial high-rate characteristic is rather deteriorated.

That is, by (i) adjusting the ion permeability barrier energy of the nonaqueous electrolyte secondary battery separator so that the ion permeability barrier energy falls within a suitable range as described above and (ii) adjusting the capacitance of each of the positive electrode plate and the negative electrode plate so that the capacitance falls within a suitable range, it is considered that the nonaqueous electrolyte secondary battery including these members has an sufficiently excellent charge capacity characteristic at the measurement of the initial high-rate characteristic.

Note that the term “measurement area” herein means an area of a portion of a measurement electrode (upper (main) electrode, probe electrode) of an LCR meter which portion is in contact with a measurement target (the porous film, the positive electrode plate, or the negative electrode plate) in a case where a capacitance is measured by the method for measuring a capacitance (later described). Therefore, a value of a capacitance per measurement area of X mm² means a value obtained in a case where a capacitance is measured with use of an LCR meter while a measurement target and a measurement electrode are in contact with each other such that an area of a portion of the measurement electrode which portion is in contact with the measurement target is X mm².

<Method for Adjusting Capacitance>

It is possible to control the capacitance of the positive electrode plate per measurement area of 900 mm² by adjusting a surface area of the positive electrode mix layer. Similarly, it is possible to control the capacitance of the negative electrode plate per measurement area of 900 mm² by adjusting a surface area of the negative electrode mix layer. Specifically, by, for example, rubbing a surface of each of the positive electrode mix layer and the negative electrode mix layer with use of an abrasive paper or the like, it is possible to increase the surface area of each of the positive electrode mix layer and the negative electrode mix layer, and ultimately possible to increase the capacitance of each of the positive electrode plate and the negative electrode plate.

Alternatively, it is possible to adjust the capacitance of the positive electrode plate per measurement area of 900 mm² by adjusting a relative dielectric constant of a material of which the positive electrode plate is made, and it is possible to control the capacitance of the negative electrode plate per measurement area of 900 mm² by adjusting a relative dielectric constant of a material of which the negative electrode plate is made. The relative dielectric constant can be adjusted by changing shapes of the voids, a porosity, and distribution of the voids of each of the positive electrode plate and the negative electrode plate. The relative dielectric constant can be alternatively controlled by adjusting the material of which each of the positive electrode plate and the negative electrode plate is made.

<Method for Measuring Capacitance>

(Method for Measuring Capacitance of Electrode Plate)

According to an embodiment of the present invention, the capacitance of the electrode plate (the positive electrode plate or the negative electrode plate) per measurement area of 900 mm² is measured with use of an LCR meter. Measurement is carried out at a frequency of 300 KHz while measurement conditions are set as follows: CV: 0.010 V, SPEED: SLOW2, AVG: 8, CABLE: 1 m, OPEN: All, SHORT: All DCBIAS 0.00 V.

Under the above measurement conditions, the capacitance of the electrode plate which is for a nonaqueous electrolyte secondary battery and which has not been included in the nonaqueous electrolyte secondary battery is measured. Note that a value of a capacitance is a unique value determined depending on a shape (surface area) of a solid insulating material (the electrode plate for a nonaqueous electrolyte secondary battery), a material of which the solid insulating material is made, shapes of voids in the solid insulating material, a porosity of the solid insulating material, distribution of the voids, and the like. Therefore, the value of the capacitance of the electrode plate for a nonaqueous electrolyte secondary battery, which electrode plate has been included in the nonaqueous electrolyte secondary battery, is equivalent to that of the capacitance of the electrode plate which has not been included in the nonaqueous electrolyte secondary battery.

Note that the capacitance of each of the positive electrode plate and the negative electrode plate can be measured after (i) the positive electrode plate and the negative electrode plate are included in the nonaqueous electrolyte secondary battery, (ii) the nonaqueous electrolyte secondary battery are charged and discharged, and then (iii) the positive electrode plate and the negative electrode plate are taken out from the nonaqueous electrolyte secondary battery.

Specifically, the following method can be, for example, employed. That is, an electrode laminated body (a member for a nonaqueous electrolyte secondary battery (hereinafter referred to as a “nonaqueous electrolyte secondary battery member”)) is taken out from an exterior member of the nonaqueous electrolyte secondary battery, and is dismantled to take out one electrode plate (the positive electrode plate or the negative electrode plate). From the one electrode plate thus taken out, a test piece is cut off which has a size similar to that of the electrode plate serving as a measurement target in the above-described method for measuring a capacitance of an electrode plate. Subsequently, the test piece thus obtained is cleaned several times (for example, three times) in diethyl carbonate (DEC). The cleaning is a step of removing the electrolyte, a product of decomposition of the electrolyte, a lithium salt, and the like, each adhering to a surface of the electrode plate, by (i) putting and cleaning the test piece in the DEC and then (ii) repeating, several times (for example, three times), a procedure of replacing the DEC with new DEC and cleaning the test piece in the new DEC. The electrode plate which has been cleaned is sufficiently dried, and is then used as a measurement target electrode. A type of the exterior member of the nonaqueous electrolyte secondary battery, from which exterior member the positive electrode plate and the negative electrode plate are taken out, is not limited to any particular type. Similarly, a structure of the electrode laminated body, from which the positive electrode plate and the negative electrode plate are taken out, is not limited to any particular structure.

(Positive Electrode Plate)

The positive electrode plate of the nonaqueous electrolyte secondary battery in accordance with an embodiment of the present invention is not limited to any particular one, provided that the positive electrode plate has a capacitance of not less than 1 nF and not more than 1000 nF per measurement area of 900 mm². For example, the positive electrode plate is a sheet-shaped positive electrode plate including (i) a positive electrode mix containing a positive electrode active material, an electrically conductive agent, and a binding agent and (ii) a positive electrode current collector supporting the positive electrode mix thereon. Note that the positive electrode plate can be arranged such that the positive electrode current collector supports positive electrode mixes on respective both surfaces of the positive electrode current collector or can be alternatively arranged such that the positive electrode current collector supports the positive electrode mix on one surface of the positive electrode current collector.

Examples of the positive electrode active material include materials each capable of being doped with and dedoped of metal ions such as lithium ions or sodium ions. Specifically, of the materials, transition metal oxides are preferable. Examples of the transition metal oxides include lithium complex oxides each containing at least one transition metal such as V, Mn, Fe, Co, or Ni.

Of the above lithium complex oxides, (i) lithium complex oxides each having an α-NaFeO₂ structure, such as lithium nickelate and lithium cobaltate, and (ii) lithium complex oxides each having a spinel structure, such as lithium manganese spinel, are more preferable, because such lithium complex oxides each have a high average discharge potential. The lithium complex oxides each containing at least one transition metal can each further contain any of various metal elements, and complex lithium nickelate is still more preferable.

Further, the complex lithium nickelate particularly preferably contains at least one metal element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to a sum of the number of moles of the at least one metal element and the number of moles of Ni in lithium nickelate. This is because, in a case where the nonaqueous electrolyte secondary battery having a high capacity is used, such a complex lithium nickelate allows the nonaqueous electrolyte secondary battery to have an excellent cycle characteristic.

Examples of the electrically conductive agent include carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents (for example, artificial graphite and carbon black) can be used in combination.

Examples of the binding agent include: thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene; an acrylic resin; and styrene-butadiene-rubber. Note that the binding agent functions also as a thickener. Note that the binding agent functions also as a thickener. Each of these binding agents can be used solely. Alternatively, two or more of these binding agents can be used in combination.

Examples of a method for obtaining the positive electrode mix include: a method in which the positive electrode active material, the electrically conductive agent, and the binding agent are pressured on the positive electrode current collector; and a method in which the positive electrode active material, the electrically conductive agent, and the binding agent are formed into a paste with use of an appropriate organic solvent.

Examples of the positive electrode current collector include electric conductors such as Al, Ni, and stainless steel. Of these electric conductors, Al is more preferable because Al is easily processed into a thin film and is inexpensive.

Examples of a method for producing the sheet-shaped positive electrode plate, i.e., a method for causing the positive electrode current collector to support the positive electrode mix include: a method in which the positive electrode active material, the electrically conductive agent, and the binding agent which constitute the positive electrode mix are pressure-molded on the positive electrode current collector; and a method in which (i) the positive electrode active material, the electrically conductive agent, and the binding agent are formed into a paste with use of an appropriate organic solvent to obtain the positive electrode mix, (ii) the positive electrode current collector is coated with the positive electrode mix, and then (iii) a sheet-shaped positive electrode mix obtained by drying the positive electrode mix is pressured on the positive electrode current collector so that the sheet-shaped positive electrode mix is firmly fixed to the positive electrode current collector.

(Negative Electrode Plate)

The negative electrode plate of the nonaqueous electrolyte secondary battery in accordance with an embodiment of the present invention is not limited to any particular one, provided that the negative electrode plate has a capacitance of not less than 4 nF and not more than 8500 nF per measurement area of 900 mm². For example, the negative electrode plate is a sheet-shaped negative electrode plate including (i) a negative electrode mix containing a negative electrode active material and (ii) a negative electrode current collector supporting the negative electrode mix thereon. The sheet-shaped negative electrode plate preferably contains an electrically conductive agent as described above and a binding agent as described above. Note that the negative electrode plate can be arranged such that the negative electrode current collector supports negative electrode mixes on respective both surfaces of the negative electrode current collector or can be alternatively arranged such that the negative electrode current collector supports the negative electrode mix on one surface of the negative electrode current collector.

Examples of the negative electrode active material include materials each capable of being doped with and dedoped of metal ions such as lithium ions or sodium ions. Specific examples of the materials include: carbonaceous materials such as natural graphite, artificial graphite, cokes, carbon black, pyrolytic carbons, carbon fiber, and a fired product of an organic polymer compound; and chalcogen compounds, such as an oxide and a sulfide, each of which is doped with and dedoped of lithium ions at an electric potential lower than that for the positive electrode plate.

Of the above negative electrode active materials, a negative electrode active material containing graphite is preferable, and a carbonaceous material containing a graphite material, such as natural graphite or artificial graphite, as a main component is more preferable, because such negative electrode active materials each have high electric potential flatness and low average discharge potential and, therefore, achieve high energy density when combined with the positive electrode plate. Further, the negative electrode active material can be a negative electrode active material containing graphite as a main component and further containing silicon.

Examples of a method for obtaining the negative electrode mix include: a method in which the negative electrode active material is pressured on the negative electrode current collector; and a method in which the negative electrode active material is formed into a paste with use of an appropriate organic solvent.

Examples of the negative electrode current collector include electric conductors such as Cu, Ni, and stainless steel. Of these electric conductors, Cu is more preferable because Cu is not easily alloyed with lithium particularly in a lithium-ion secondary battery and is easily processed into a thin film.

Examples of a method for producing the sheet-shaped negative electrode plate, i.e., a method for causing the negative electrode current collector to support the negative electrode mix include: a method in which the negative electrode active material which constitutes the negative electrode mix is pressure-molded on the negative electrode current collector; and a method in which (i) the negative electrode active material is formed into a paste with use of an appropriate organic solvent to obtain the negative electrode mix, (ii) the negative electrode current collector is coated with the negative electrode mix, and then (iii) a sheet-shaped negative electrode mix obtained by drying the negative electrode mix is pressured on the negative electrode current collector so that the sheet-shaped negative electrode mix is firmly fixed to the negative electrode current collector. The paste preferably contains an electrically conductive agent as described above and a binding agent as described above.

(Nonaqueous Electrolyte)

A nonaqueous electrolyte which can be contained in the nonaqueous electrolyte secondary battery in accordance with an embodiment of the present invention can be a nonaqueous electrolyte prepared by, for example, dissolving a lithium salt in an organic solvent which is an electrolyte solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. Each of these lithium salts can be used solely. Alternatively, two or more of these lithium salts can be used in combination.

Of the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

The electrolyte solvent is not limited to any particular one. Specific examples of the electrolyte solvent include: carbonates such as ethylene carbonate (EC), propylene carbonate (PMC), dimethyl carbonate (DMC), diethyl carbonate (DEC), ethyl methyl carbonate (EMC), 4-trifluoromethyl-1,3-dioxolane-2-one, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into an organic solvent as described above. Each of these organic solvents can be used solely. Alternatively, two or more of these organic solvents can be used in combination.

Of the above organic solvents, carbonates are more preferable, and a mixed solvent of a cyclic carbonate and an acyclic carbonate or a mixed solvent of a cyclic carbonate and an ether is still more preferable. As the mixed solvent of a cyclic carbonate and an acyclic carbonate, a mixed solvent of ethylene carbonate, dimethyl carbonate, and ethyl methyl carbonate is still more preferable, because such a mixed solvent allows a wider operating temperature range and is not easily decomposed even in a case where a graphite material such as natural graphite or artificial graphite is used as the negative electrode active material.

[Method for Producing Nonaqueous Electrolyte Secondary Battery]

The nonaqueous electrolyte secondary battery in accordance with an embodiment of the present invention can be produced by, for example, (i) forming the nonaqueous electrolyte secondary battery member by disposing the positive electrode plate, the nonaqueous electrolyte secondary battery separator, and the negative electrode plate in this order, (ii) placing the nonaqueous electrolyte secondary battery member in a container which is to serve as a housing of the nonaqueous electrolyte secondary battery, (iii) filling the container with the nonaqueous electrolyte, and then (iv) hermetically sealing the container while reducing pressure inside the container. A shape of the nonaqueous electrolyte secondary battery is not limited to any particular one. The nonaqueous electrolyte secondary battery can have any shape such as a shape of a thin plate (sheet), a disk, a cylinder, or a prism such as a cuboid. Note that a method for producing the nonaqueous electrolyte secondary battery in accordance with an embodiment of the present invention is not limited to any particular one, and a conventionally publicly known method can be employed.

[Nonaqueous Electrolyte Secondary Battery Member]

The nonaqueous electrolyte secondary battery member in accordance with an embodiment of the present invention is a nonaqueous electrolyte secondary battery member including a positive electrode plate, a nonaqueous electrolyte secondary battery separator, and a negative electrode plate which are disposed in this order, the nonaqueous electrolyte secondary battery separator having ion permeability barrier energy of not less than 300 J/mol/μm and not more than 900 J/mol/μm per unit film thickness, the positive electrode plate having a capacitance of not less than 1 nF and not more than 1000 nF per measurement area of 900 mm², the negative electrode plate having a capacitance of not less than 4 nF and not more than 8500 nF per measurement area of 900 mm².

Since the nonaqueous electrolyte secondary battery member in accordance with an embodiment of the present invention has the above configuration, it is possible for the nonaqueous electrolyte secondary battery including the nonaqueous electrolyte secondary battery member to have an improved charge capacity characteristic at the measurement of the initial high-rate characteristic.

The positive electrode plate, the negative electrode plate, and the nonaqueous electrolyte secondary battery separator are identical, in configuration, to those described as members of the nonaqueous electrolyte secondary battery in accordance with Embodiment 1 of the present invention. Therefore, the positive electrode plate, the negative electrode plate, and the nonaqueous electrolyte secondary battery separator will not be described here.

The present invention is not limited to the above-described embodiment, but may be altered in various ways by a skilled person within the scope of the claims. The present invention also encompasses, in its technical scope, any embodiment derived by combining technical means disclosed in differing embodiments. Further, it is possible to form a new technical feature by combining technical means disclosed in respective embodiments.

### EXAMPLES

The present invention will be described below in more detail with reference to Examples and Comparative Examples. Note, however, that the present invention is not limited to such Examples.

[Measurement Methods]

Physical properties of electrode plates (positive electrode plates or negative electrode plates) and nonaqueous electrolyte secondary battery separators, used in Examples 1 through 7 and Comparative Examples 1 through 3, were measured by methods below. Furthermore, charge capacity characteristics at measurement of initial high-rate characteristics of nonaqueous electrolyte secondary batteries, used in Examples 1 through 7 and Comparative Examples 1 through 3, were measured by a method below.

(1) Film Thickness (Unit: μm)

A film thickness of a nonaqueous electrolyte secondary battery separator and thicknesses of a positive electrode plate and a negative electrode plate were measured with use of a high-precision digital length measuring machine (VL-50) manufactured by Mitutoyo Corporation.

(2) Ion Permeability Barrier Energy Per Unit Film Thickness of Nonaqueous Electrolyte Secondary Battery Separator (Unit: J/Mol/μm)

A nonaqueous electrolyte secondary battery separator (polyolefin porous film), used in each of Examples 1 through 7 and Comparative Examples 1 through 3, was cut into a disc-shaped piece having a diameter of 17 mm. The disc-shaped piece was sandwiched between two SUS plates each having a thickness of 0.5 mm and a diameter of 15.5 mm. An electrolyte was injected into a cell thus obtained so as to prepare a coin cell (CR2032 type). Here, as the electrolyte, a solution was used which was obtained by dissolving LiPF₆ in a mixed solvent, in which ethylene carbonate (EC), ethyl methyl carbonate (EMC), and diethyl carbonate (DEC) were mixed at a volume ratio of 3:5:2, so that a concentration of the LiPF₆ became 1 mol/L.

The coin cell thus prepared was placed in a thermostatic bath in which a temperature was set to a given temperature (later described). Next, a Nyquist plot was obtained with use of an alternating current impedance apparatus (FRA 1255B) and CellTest System (1470E), each manufactured by Solartron, while a frequency was set to 1 MHz to 0.1 Hz and a voltage amplitude was set to 10 mV. A solution resistance r₀ of the nonaqueous electrolyte secondary battery separator at the given temperature was determined from a value of an X intercept of the Nyquist plot. With use of obtained values, ion permeability barrier energy was calculated by the following expressions (1) and (2). The temperature of the thermostatic bath was set to 50° C., 25° C., 5° C., and −10° C.

Here, the ion permeability barrier energy is represented by the following expression (1).

k=1/r₀=Aexp(−Ea/RT) (1)

Ea: ion permeability barrier energy (J/mol)
k: a reaction constant
r₀: a solution resistance (Ω)
A: a frequency factor
R: a gas constant=8.314 J/mol/K
T: a temperature of a thermostatic bath (K)

In a case where natural logarithms of both sides of the expression (1) are taken, the following expression (2) is obtained. On the basis of the expression (2), −Ea/R was determined which indicated a slope of a straight line obtained by (i) plotting ln(1/r₀) with respect to a reciprocal of each temperature and (ii) applying a least squares method to a plot thus obtained, and then Ea was calculated by multiplying a value of −Ea/R by a gas constant R. Subsequently, Ea thus calculated was divided by a film thickness of the nonaqueous electrolyte secondary battery separator. In this way, the ion permeability barrier energy per unit film thickness was calculated.

ln(k)=ln(1/r₀)=ln A−Ea/RT (2)

(3) Measurement of Capacitance of Electrode Plate

A capacitance of each of a positive electrode plate and a negative electrode plate per measurement area of 900 mm², which positive electrode plate and negative electrode plate were obtained in each of Examples 1 through 7 and Comparative Examples 1 through 3, was measured with use of an LCR meter (model number: IM3536) manufactured by HIOKI E.E. CORPORATION. Measurement was carried out at a frequency of 300 KHz while measurement conditions were set as follows: CV: 0.010 V, SPEED: SLOW2, AVG: 8, CABLE: 1 m, OPEN: All, SHORT: All DCBIAS 0.00 V. An absolute value of the capacitance thus measured was regarded as a capacitance per measurement area of 900 mm².

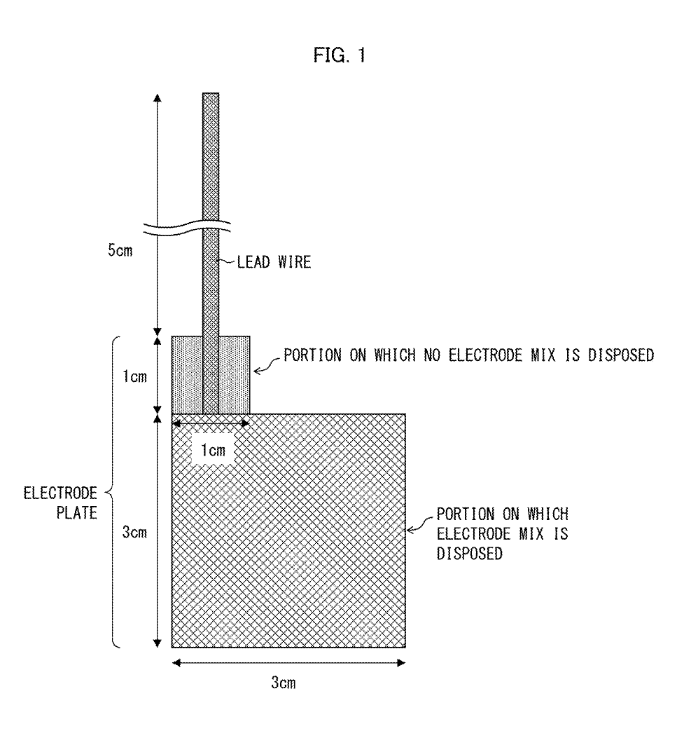

Specifically, from an electrode plate which was a measurement target, a single piece was cut off so that the single piece had (i) a first portion which had a 3 cm×3 cm square shape and on which an electrode mix was disposed and (ii) a second portion which had a 1 cm×1 cm square shape and on which no electrode mix was disposed. To the second portion of the single piece thus cut off from the electrode plate, a lead wire, having a length of 6 cm and a width of 0.5 cm, was ultrasonically welded to obtain an electrode plate whose capacitance was to be measured. FIG. 1 is a view schematically illustrating a measurement target electrode whose capacitance was to be measured. An aluminum lead wire was used for the positive electrode plate, and a nickel lead wire was used for the negative electrode plate.

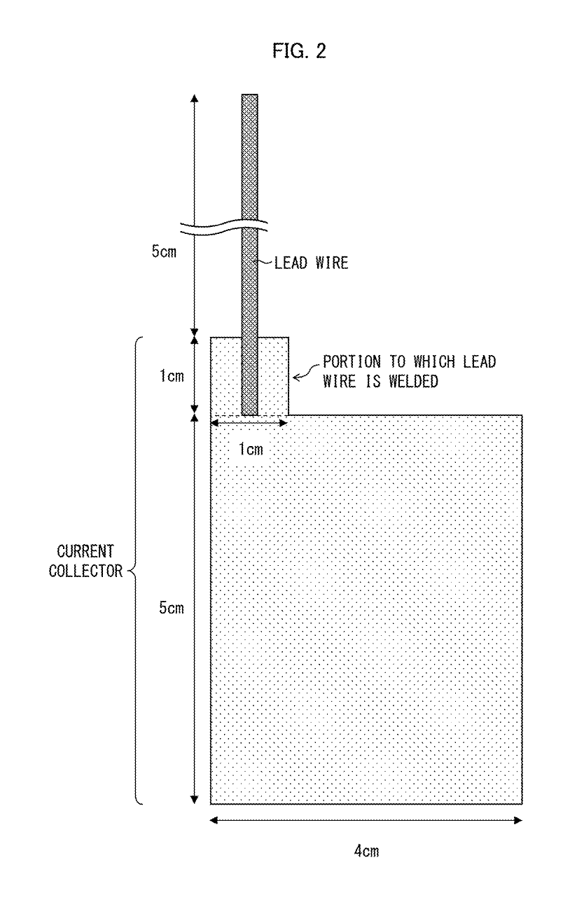

From a current collector, a single piece was cut off so that the single piece had (i) a first portion which had a 5 cm×4 cm rectangular shape and (ii) a second portion which had a 1 cm×1 cm square shape and to which a lead wire was to be welded. To the second portion of the single piece thus cut off from the current collector, a lead wire, having a length of 6 cm and a width of 0.5 cm, was ultrasonically welded to obtain a probe electrode (measurement electrode). FIG. 2 is a view schematically illustrating the probe electrode which was used for measurement of the capacitance. An aluminum probe electrode having a thickness of 20 μm was used to measure the capacitance of the positive electrode plate, and a copper probe electrode having a thickness of 20 μm was used to measure the capacitance of the negative electrode plate.

Thereafter, the probe electrode was laid over the first portion (portion having a 3 cm×3 cm square shape) of the electrode plate, whose capacitance was to be measured, to prepare a laminated body. The laminated body thus obtained was sandwiched between two sheets of silicon rubber. A resultant laminated body was further sandwiched between two SUS plates with a pressure of 0.7 MPa to obtain a laminated body which was to be subjected to the measurement. The lead wire of the electrode plate, whose capacitance was to be measured, and the lead wire of the probe electrode were drawn outside the laminated body which was to be subjected to the measurement. Each of a voltage terminal and an electric current terminal of the LCR meter was connected to those lead wires so that the voltage terminal was closer to the electrode plate than the electric current terminal.

(4) Measurement of Porosity of Positive Electrode Mix Layer

A porosity of a positive electrode mix layer included in a positive electrode plate used in Example 1 was measured by a method below. A porosity of a positive electrode mix layer included in each of the other positive electrode plates used in Examples 2 through 7 and Comparative Examples 1 through 3 was also measured by a similar method.

A positive electrode plate, arranged such that a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil), was cut to obtain a piece having a size of 14.5 cm² (4.5 cm×3 cm+1 cm×1 cm). A resultant cut piece of the positive electrode plate had a mass of 0.215 g and had a thickness of 58 μm. The positive electrode current collector was cut to obtain a piece having the same size as the cut piece of the positive electrode plate. A resultant cut piece of the positive electrode current collector had a mass of 0.078 g and had a thickness of 20 μm.

A density ρ of such a positive electrode mix layer was calculated as (0.215−0.078)/{(58−20)/10000×14.5}=2.5 g/cm³.

Each of materials contained in the positive electrode mix had a real density as follows: the LiNi_{0.5}Mn_{0.3}CO_{0.2}O₂, the electrically conductive agent, and the PVDF had real densities of 4.68 g/cm³, 1.8 g/cm³, and 1.8 g/cm³, respectively.

The positive electrode mix layer had a porosity ε of 40%, which was calculated with use of the above values by the following expression:

ε=[1−{2.5×(92/100)/4.68+2.5×(5/100)/1.8+2.5×(3/100)/1.8}]×100=40%

(5) Measurement of Porosity of Negative Electrode Mix Layer

A porosity of a negative electrode mix layer included in a negative electrode plate prepared in Example 1 was measured by a method below. A porosity of a negative electrode mix layer included in each of the other negative electrode plates prepared in Examples 2 through 7 and Comparative Examples 1 through 3 was also measured by a similar method.

A negative electrode plate, arranged such that a negative electrode mix (a mixture of graphite, a styrene-1,3-butadiene copolymer, and sodium carboxymethyl cellulose (at a weight ratio of 98:1:1)) was disposed on one surface of a negative electrode current collector (copper foil), was cut to obtain a piece having a size of 18.5 cm² (5 cm×3.5 cm+1 cm×1 cm). A resultant cut piece of the negative electrode plate had a mass of 0.266 g and had a thickness of 48 μm. The negative electrode current collector was cut to obtain a piece having the same size as the cut piece of the negative electrode plate. A resultant cut piece of the negative electrode current collector had a mass of 0.162 g and had a thickness of 10 μm.

A density ρ of such a negative electrode mix layer was calculated as (0.266−0.162)/{(48−10)/10000×18.5}=1.49 g/cm³.

Each of materials contained in the negative electrode mix had a real density as follows: the graphite, the styrene-1,3-butadiene copolymer, and the sodium carboxymethyl cellulose had real densities of 2.2 g/cm³, 1 g/cm³, and 1.6 g/cm³, respectively.

The negative electrode mix layer had a porosity ε of 31%, which was calculated with use of the above values by the following expression:

ε=[1−{1.49×(98/100)/2.2+1.49×(1/100)/1+1.49×(1/100)/1.6}]×100=31%

(6) Battery Characteristic of Nonaqueous Electrolyte Secondary Battery

A charge capacity characteristic at measurement of an initial high-rate characteristic of a nonaqueous electrolyte secondary battery prepared in each of Examples and Comparative Examples was measured by a method including the following steps (A) and (B).

(A) Initial Charge-Discharge Test

A new nonaqueous electrolyte secondary battery, which employed a nonaqueous electrolyte secondary battery separator prepared in each of Examples 1 through 7 and Comparative Example 1 through 3 and which had not been subjected to any charge-discharge cycle, was subjected to 4 initial charge-discharge cycles. Each of the 4 initial charge-discharge cycles was carried out under the following conditions: (i) a temperature was set to 25° C.; (ii) a voltage was set to a range of 2.7 V to 4.1 V; (iii) CC-CV charge was carried out at a rate of 0.2 C (final rate: 0.02 C); and (iv) CC discharge was carried out at a rate of 0.2 C. Note that 1 C indicates a rate at which a rated capacity derived from a 1-hour rate discharge capacity is discharged in 1 hour. The same applies to the following description.

Note, here, that the “CC-CV charge” is a charging method in which (i) a battery is charged with a constant electric current set and (ii) after a certain voltage is reached, the certain voltage is maintained while the electric current is reduced. Note also that the “CC discharge” is a discharging method in which a battery is discharged with a constant electric current set until a certain voltage is reached. The same applies to the following description.

(B) Charge Capacity Characteristic at Measurement of Initial High-Rate Characteristic (Unit: mAh)

The nonaqueous electrolyte secondary battery which had been subjected to the 4 initial charge-discharge cycles was subjected to charge-discharge cycles under the following conditions: (i) a temperature was set to 55° C.; (ii) CC-CV charge was carried out at a rate of 1 C (final rate: 0.02 C); and (iii) CC discharge was carried out in such a manner that a rate was first set to 0.2 C and then changed to 1 C, 5 C, and 10 C in this order every 3 charge-discharge cycles. In so doing, a voltage was set to a range of 2.7 V to 4.2 V. A charge capacity at 1 C charge in the third one of 3 charge-discharge cycles in which 10 C discharge was carried out was measured, and regarded as a charge capacity at measurement of a high-rate characteristic.

### Example 1

[Preparation of Nonaqueous Electrolyte Secondary Battery Separator]

First, 18 parts by weight of an ultra-high molecular weight polyethylene powder (HI-ZEX MILLION 145M, manufactured by Mitsui Chemicals, Inc.) and 2 parts by weight of a petroleum resin having many tertiary carbon atoms in its structure (alicyclic saturated hydrocarbon resin having a softening point of 90° C.) were prepared. Those powders were pulverized and mixed with use of a blender. Note that pulverization was carried out until particles of the powders were identical in particle diameter. A mixture 1 was thus obtained.

Next, the mixture 1 was fed to a twin screw kneading extruder with use of a quantitative feeder, and then melt-kneaded in the twin screw kneading extruder. A temperature inside the twin screw kneading extruder immediately before liquid paraffin was fed to the twin screw kneading extruder was set to 144° C., and 80 parts by weight of the liquid paraffin was side-fed to the twin screw kneading extruder with use of a pump. Note that the “temperature inside the twin screw kneading extruder” indicates a temperature inside a segment-type barrel of a twin screw kneading extruder. Note also that the “segment-type barrel” indicates a block-type barrel which can be connected to a different block-type barrel(s) so that connected block-type barrels have an intended total length.

Subsequently, a resultant melt-kneaded mixture 1 was extruded through a T-die, in which a temperature was set to 210° C., via a gear pump so that the melt-kneaded mixture 1 was shaped into a sheet. A sheet thus obtained was employed as a sheet-shaped polyolefin resin composition 1. The sheet-shaped polyolefin resin composition 1 was then wound on a cooling roller so that the sheet-shaped polyolefin resin composition 1 was cooled down. After the sheet-shaped polyolefin resin composition was cooled down, the sheet-shaped polyolefin resin composition 1 was stretched by a sequential stretching method, that is, the sheet-shaped polyolefin resin composition 1 was stretched in an MD at a stretch ratio of 6.4 times and then stretched in a TD at a stretch ratio of 6.0 times to obtain a stretched polyolefin resin composition 2.

The stretched polyolefin resin composition 2 was cleaned with use of a cleaning liquid (heptane). A resultant cleaned sheet (sheet-shaped polyolefin resin composition) was left to stand still for 1 minute in a ventilation oven, in which a temperature was set to 118° C., so that the cleaned sheet was dried and heat-fixed. In this manner, a polyolefin porous film was obtained. The polyolefin porous film thus obtained was employed as a nonaqueous electrolyte secondary battery separator 1.

Thereafter, physical properties of the nonaqueous electrolyte secondary battery separator 1 were measured by the respective above-described measurement methods. The nonaqueous electrolyte secondary battery separator 1 had a film thickness of 23 μm and an air permeability of 128 sec/100 mL.

[Preparation of Nonaqueous Electrolyte Secondary Battery]

(Preparation of Positive Electrode Plate)

A positive electrode was used which had been prepared by applying LiNi_{0.5}Mn_{0.3}CO_{0.2}O₂, an electrically conductive agent, and PVDF (at a weight ratio of 92:5:3) to aluminum foil. The aluminum foil of the positive electrode was cut so that (i) a first portion of the aluminum foil, on which first portion a positive electrode active material layer was formed, had a size of 45 mm×30 mm and (ii) a second portion of the aluminum foil, on which second portion no positive electrode active material layer was formed and which second portion had a width of 13 mm, remained on an outer periphery of the first portion. A positive electrode thus obtained was used as a positive electrode plate. The positive electrode plate was employed as a positive electrode plate 1. In the positive electrode plate 1, the positive electrode active material layer had a thickness of 58 μm and a density of 2.50 g/cm³.

(Preparation of Negative Electrode)

A negative electrode was used which had been prepared by applying graphite, a styrene-1,3-butadiene copolymer, and sodium carboxymethylcellulose (at a weight ratio of 98:1:1) to copper foil. The copper foil of the negative electrode was cut so that (i) a first portion of the copper foil, on which first portion a negative electrode active material layer was formed, had a size of 50 mm×35 mm and (ii) a second portion of the copper foil, on which second portion no negative electrode active material layer was formed and which second portion had a width of 13 mm, remained on an outer periphery of the first portion. A negative electrode thus obtained was used as a negative electrode plate. The negative electrode plate was employed as a negative electrode plate 1. In the negative electrode plate 1, the negative electrode active material layer had a thickness of 49 μm and a density of 1.40 g/cm³.

(Assembly of Nonaqueous Electrolyte Secondary Battery)

A nonaqueous electrolyte secondary battery was prepared by the following method with use of the positive electrode plate 1, the negative electrode plate 1, and the nonaqueous electrolyte secondary battery separator 1.

The positive electrode plate 1, the nonaqueous electrolyte secondary battery separator 1, and the negative electrode plate 1 were disposed (arranged) in this order in a laminate pouch to obtain a nonaqueous electrolyte secondary battery member 1. In so doing, the positive electrode plate 1 and the negative electrode plate 1 were arranged so that a main surface of the positive electrode active material layer of the positive electrode plate 1 was entirely included in a range of a main surface of the negative electrode active material layer of the negative electrode plate 1 (i.e., entirely covered by the main surface of the negative electrode active material layer of the negative electrode plate 1).

Subsequently, the nonaqueous electrolyte secondary battery member 1 was put into a bag which had been formed by disposing an aluminum layer on a heat seal layer. Further, 0.25 mL of a nonaqueous electrolyte was put into the bag. The nonaqueous electrolyte was a nonaqueous electrolyte prepared by dissolving LiPF₆ in a mixed solvent, in which ethylene carbonate, ethyl methyl carbonate, and diethyl carbonate were mixed at a volume ratio of 3:5:2, so that a concentration of the LiPF₆ became mol/L. The bag was then heat-sealed while pressure inside the bag was reduced, so that a nonaqueous electrolyte secondary battery 1 was prepared.

Thereafter, a charge capacity characteristic at measurement of an initial high-rate characteristic of the nonaqueous electrolyte secondary battery 1 was measured. Table 1 shows a result of measuring the charge capacity characteristic at the measurement of the initial high-rate characteristic.

### Example 2

[Preparation of Nonaqueous Electrolyte Secondary Battery Separator]

A polyolefin porous film was obtained as in Example 1, except that a sheet cleaned with use of a cleaning liquid (heptane) was left to stand still at 100° C. for 9 minutes so that the sheet was dried and heat-fixed. The polyolefin porous film thus obtained was employed as a nonaqueous electrolyte secondary battery separator 2.

Thereafter, physical properties of the nonaqueous electrolyte secondary battery separator 2 were measured by the respective above-described measurement methods. The nonaqueous electrolyte secondary battery separator 2 had a film thickness of 20 μm and an air permeability of 105 sec/100 mL.

[Preparation of Nonaqueous Electrolyte Secondary Battery]

A nonaqueous electrolyte secondary battery was prepared as in Example 1, except that the nonaqueous electrolyte secondary battery separator 2 was used, instead of the nonaqueous electrolyte secondary battery separator 1, as a nonaqueous electrolyte secondary battery separator. The nonaqueous electrolyte secondary battery thus prepared was employed as a nonaqueous electrolyte secondary battery 2.

Thereafter, a charge capacity characteristic at measurement of an initial high-rate characteristic of the nonaqueous electrolyte secondary battery 2 was measured. Table 1 shows a result of measuring the charge capacity characteristic at the measurement of the initial high-rate characteristic.

### Example 3

[Preparation of Nonaqueous Electrolyte Secondary Battery Separator]

A polyolefin porous film was obtained as in Example 1, except that a sheet cleaned with use of a cleaning liquid (heptane) was left to stand still at 134° C. for 16 minutes so that the sheet was dried and heat-fixed. The polyolefin porous film thus obtained was employed as a nonaqueous electrolyte secondary battery separator 3.

Thereafter, physical properties of the nonaqueous electrolyte secondary battery separator 3 were measured by the respective above-described measurement methods. The nonaqueous electrolyte secondary battery separator 3 had a film thickness of 12 μm and an air permeability of 124 sec/100 mL.

[Preparation of Nonaqueous Electrolyte Secondary Battery]

A nonaqueous electrolyte secondary battery was prepared as in Example 1, except that the nonaqueous electrolyte secondary battery separator 3 was used, instead of the nonaqueous electrolyte secondary battery separator 1, as a nonaqueous electrolyte secondary battery separator. The nonaqueous electrolyte secondary battery thus prepared was employed as a nonaqueous electrolyte secondary battery 3.

Thereafter, a charge capacity characteristic at measurement of an initial high-rate characteristic of the nonaqueous electrolyte secondary battery 3 was measured. Table 1 shows a result of measuring the charge capacity characteristic at the measurement of the initial high-rate characteristic.

### Example 4

[Preparation of Nonaqueous Electrolyte Secondary Battery]

(Preparation of Positive Electrode Plate)

A surface of a positive electrode plate, identical to the positive electrode plate 1, which surface was located on a positive electrode mix layer side was rubbed 3 times with use of an abrasive cloth sheet (model: TYPE AA GRIT No. 100) manufactured by Nagatsuka Abrasive Mfg. Co. Ltd. In this manner, a positive electrode plate was obtained. The positive electrode plate thus obtained was employed as a positive electrode plate 2. In the positive electrode plate 2, a positive electrode mix layer had a thickness of 38 μm and a porosity of 40%.

(Assembly of Nonaqueous Electrolyte Secondary Battery)

A nonaqueous electrolyte secondary battery was prepared as in Example 1, except that (i) the nonaqueous electrolyte secondary battery separator 2 obtained in Example 2 was used, instead of the nonaqueous electrolyte secondary battery separator 1, as a nonaqueous electrolyte secondary battery separator and (ii) the positive electrode plate 2 was used, instead of the positive electrode plate 1, as a positive electrode plate. The nonaqueous electrolyte secondary battery thus prepared was employed as a nonaqueous electrolyte secondary battery 4.

Thereafter, a charge capacity characteristic at measurement of an initial high-rate characteristic of the nonaqueous electrolyte secondary battery 4 was measured. Table 1 shows a result of measuring the charge capacity characteristic at the measurement of the initial high-rate characteristic.

### Example 5

[Preparation of Nonaqueous Electrolyte Secondary Battery]

(Preparation of Positive Electrode Plate)

A surface of a positive electrode plate, identical to the positive electrode plate 1, which surface was located on a positive electrode mix layer side was rubbed 5 times with use of an abrasive cloth sheet (model: TYPE AA GRIT No. 100) manufactured by Nagatsuka Abrasive Mfg. Co. Ltd. In this manner, a positive electrode plate was obtained. The positive electrode plate thus obtained was employed as a positive electrode plate 3. In the positive electrode plate 3, a positive electrode mix layer had a thickness of 38 μm and a porosity of 40%.

(Assembly of Nonaqueous Electrolyte Secondary Battery)

A nonaqueous electrolyte secondary battery was prepared as in Example 1, except that (i) the nonaqueous electrolyte secondary battery separator 2 obtained in Example 2 was used, instead of the nonaqueous electrolyte secondary battery separator 1, as a nonaqueous electrolyte secondary battery separator and (ii) the positive electrode plate 3 was used, instead of the positive electrode plate 1, as a positive electrode plate. The nonaqueous electrolyte secondary battery thus prepared was employed as a nonaqueous electrolyte secondary battery 5.

Thereafter, a charge capacity characteristic at measurement of an initial high-rate characteristic of the nonaqueous electrolyte secondary battery 5 was measured. Table 1 shows a result of measuring the charge capacity characteristic at the measurement of the initial high-rate characteristic.

### Example 6

[Preparation of Nonaqueous Electrolyte Secondary Battery]

(Preparation of Negative Electrode Plate)

A surface of a negative electrode plate, identical to the negative electrode plate 1, which surface was located on a negative electrode mix layer side was rubbed 3 times with use of an abrasive cloth sheet (model: TYPE AA GRIT No. 100) manufactured by Nagatsuka Abrasive Mfg. Co. Ltd. In this manner, a negative electrode plate was obtained. The negative electrode plate thus obtained was employed as a negative electrode plate 2. In the negative electrode plate 2, a negative electrode mix layer had a thickness of 38 μm and a porosity of 31%.

(Assembly of Nonaqueous Electrolyte Secondary Battery)

A nonaqueous electrolyte secondary battery was prepared as in Example 1, except that (i) the nonaqueous electrolyte secondary battery separator 2 obtained in Example 2 was used, instead of the nonaqueous electrolyte secondary battery separator 1, as a nonaqueous electrolyte secondary battery separator and (ii) the negative electrode plate 2 was used, instead of the negative electrode plate 1, as a negative electrode plate. The nonaqueous electrolyte secondary battery thus prepared was employed as a nonaqueous electrolyte secondary battery 6.

Thereafter, a charge capacity characteristic at measurement of an initial high-rate characteristic of the nonaqueous electrolyte secondary battery 6 was measured. Table 1 shows a result of measuring the charge capacity characteristic at the measurement of the initial high-rate characteristic.

### Example 7

[Preparation of Nonaqueous Electrolyte Secondary Battery]

(Preparation of Negative Electrode Plate)

A surface of a negative electrode plate, identical to the negative electrode plate 1, which surface was located on a negative electrode mix layer side was rubbed 7 times with use of an abrasive cloth sheet (model: TYPE AA GRIT No. 100) manufactured by Nagatsuka Abrasive Mfg. Co. Ltd. In this manner, a negative electrode plate was obtained. The negative electrode plate thus obtained was employed as a negative electrode plate 3. In the negative electrode plate 3, a negative electrode mix layer had a thickness of 38 μm and a porosity of 31%.

(Assembly of Nonaqueous Electrolyte Secondary Battery)

A nonaqueous electrolyte secondary battery was prepared as in Example 1, except that (i) the nonaqueous electrolyte secondary battery separator 2 obtained in Example 2 was used, instead of the nonaqueous electrolyte secondary battery separator 1, as a nonaqueous electrolyte secondary battery separator and (ii) the negative electrode plate 3 was used, instead of the negative electrode plate 1, as a negative electrode plate. The nonaqueous electrolyte secondary battery thus prepared was employed as a nonaqueous electrolyte secondary battery 7.

Thereafter, a charge capacity characteristic at measurement of an initial high-rate characteristic of the nonaqueous electrolyte secondary battery 7 was measured. Table 1 shows a result of measuring the charge capacity characteristic at the measurement of the initial high-rate characteristic.

### Comparative Example 1

[Preparation of Nonaqueous Electrolyte Secondary Battery Separator]

A polyolefin porous film was obtained as in Example 1, except that (i) 20 parts by weight of an ultra-high molecular weight polyethylene powder (HI-ZEX MILLION 145M, manufactured by Mitsui Chemicals, Inc.) was prepared solely and a petroleum resin was not prepared and (ii) a temperature inside a twin screw kneading extruder immediately before liquid paraffin was fed to the twin screw kneading extruder was set to 134° C. The polyolefin porous film thus obtained was employed as a nonaqueous electrolyte secondary battery separator 4.

Thereafter, physical properties of the nonaqueous electrolyte secondary battery separator 4 were measured by the respective above-described measurement methods. The nonaqueous electrolyte secondary battery separator 4 had a film thickness of 24 μm and an air permeability of 160 sec/100 mL.

[Preparation of Nonaqueous Electrolyte Secondary Battery]

A nonaqueous electrolyte secondary battery was prepared as in Example 1, except that the nonaqueous electrolyte secondary battery separator 4 was used, instead of the nonaqueous electrolyte secondary battery separator 1, as a nonaqueous electrolyte secondary battery separator. The nonaqueous electrolyte secondary battery thus prepared was employed as a nonaqueous electrolyte secondary battery 8.

Thereafter, a charge capacity characteristic at measurement of an initial high-rate characteristic of the nonaqueous electrolyte secondary battery 8 was measured. Table 1 shows a result of measuring the charge capacity characteristic at the measurement of the initial high-rate characteristic.

### Comparative Example 2

[Preparation of Nonaqueous Electrolyte Secondary Battery]

(Preparation of Positive Electrode Plate)

A surface of a positive electrode plate, identical to the positive electrode plate 1, which surface was located on a positive electrode mix layer side was rubbed 10 times with use of an abrasive cloth sheet (model: TYPE AA GRIT No. 100) manufactured by Nagatsuka Abrasive Mfg. Co. Ltd. In this manner, a positive electrode plate was obtained. The positive electrode plate thus obtained was employed as a positive electrode plate 4. In the positive electrode plate 4, a positive electrode mix layer had a thickness of 38 μm and a porosity of 40%.

(Assembly of Nonaqueous Electrolyte Secondary Battery)

A nonaqueous electrolyte secondary battery was prepared as in Example 1, except that (i) the nonaqueous electrolyte secondary battery separator 2 obtained in Example 2 was used, instead of the nonaqueous electrolyte secondary battery separator 1, as a nonaqueous electrolyte secondary battery separator and (ii) the positive electrode plate 4 was used, instead of the positive electrode plate 1, as a positive electrode plate. The nonaqueous electrolyte secondary battery thus prepared was employed as a nonaqueous electrolyte secondary battery 9.

Thereafter, a charge capacity characteristic at measurement of an initial high-rate characteristic of the nonaqueous electrolyte secondary battery 9 was measured. Table 1 shows a result of measuring the charge capacity characteristic at the measurement of the initial high-rate characteristic.

### Comparative Example 3

[Preparation of Nonaqueous Electrolyte Secondary Battery]

(Preparation of Negative Electrode Plate)

A surface of a negative electrode plate, identical to the negative electrode plate 1, which surface was located on a negative electrode mix layer side was rubbed 10 times with use of an abrasive cloth sheet (model: TYPE AA GRIT No. 100) manufactured by Nagatsuka Abrasive Mfg. Co. Ltd. In this manner, a negative electrode plate was obtained. The negative electrode plate thus obtained was employed as a negative electrode plate 4. In the negative electrode plate 4, a negative electrode mix layer had a thickness of 38 μm and a porosity of 31%.

(Assembly of Nonaqueous Electrolyte Secondary Battery)

A nonaqueous electrolyte secondary battery was prepared as in Example 1, except that (i) the nonaqueous electrolyte secondary battery separator 2 obtained in Example 2 was used, instead of the nonaqueous electrolyte secondary battery separator 1, as a nonaqueous electrolyte secondary battery separator and (ii) the negative electrode plate 4 was used, instead of the negative electrode plate 1, as a negative electrode plate. The nonaqueous electrolyte secondary battery thus prepared was employed as a nonaqueous electrolyte secondary battery 10.

Thereafter, a charge capacity characteristic at measurement of an initial high-rate characteristic of the nonaqueous electrolyte secondary battery 10 was measured. Table 1 shows a result of measuring the charge capacity characteristic at the measurement of the initial high-rate characteristic.

[Results]

TABLE 1

| | Nonaqueous | | | Nonaqueous electrolyte |
|---|---|---|---|---|
| | electrolyte | | | secondary |
| | secondary | | | battery |
| | battery | | | Charge |
| | separator | Positive | Negative | capacity |
| | Ion | electrode | electrode | characteristic |
| | permeability | plate | plate | at |
| | barrier | Capacitance | Capacitance | measurement |
| | energy per | per | per | of initial |
| | unit film | measurement | measurement | high-rate |
| | thickness | area of 900 mm² | area of 900 mm² | characteristic |
| | [J/mol/μm] | [nF] | [nF] | [mAh] |
| Example 1 | 320 | 2.1 | 4.7 | 14.5 |
| Example 2 | 465 | 2.1 | 4.7 | 18.0 |
| Example 3 | 780 | 2.1 | 4.7 | 17.3 |
| Example 4 | 465 | 60 | 4.7 | 16.8 |
| Example 5 | 465 | 935 | 4.7 | 16.8 |
| Example 6 | 465 | 2.1 | 274 | 17.0 |
| Example 7 | 465 | 2.1 | 7400 | 16.8 |
| Comparative | 290 | 2.1 | 4.7 | 13.6 |
| Example 1 | | | | |
| Comparative | 465 | 4090 | 4.7 | 8.0 |
| Example 2 | | | | |
| Comparative | 465 | 2.1 | 9050 | 9.5 |
| Example 3 | | | | |

As is clear from Table 1, the nonaqueous electrolyte secondary batteries prepared in Examples 1 through 7 were more excellent, in the charge capacity characteristic at the measurement of the initial high-rate characteristic, than the nonaqueous electrolyte secondary batteries prepared in Comparative Examples 1 through 3.

It was accordingly found that it is possible for a nonaqueous electrolyte secondary battery to have an improved charge capacity characteristic at measurement of an initial high-rate characteristic, by causing the nonaqueous electrolyte secondary battery to satisfy the following three requirements: (i) a nonaqueous electrolyte secondary battery separator has ion permeability barrier energy of not less than 300 J/mol/μm and not more than 900 J/mol/μm per unit film thickness; (ii) a positive electrode plate has a capacitance of not less than 1 nF and not more than 1000 nF per measurement area of 900 mm²; and (iii) a negative electrode plate has a capacitance of not less than 4 nF and not more than 8500 nF per measurement area of 900 mm².

### INDUSTRIAL APPLICABILITY

A nonaqueous electrolyte secondary battery in accordance with an embodiment of the present invention is excellent in charge capacity characteristic at measurement of an initial high-rate characteristic. It is therefore possible to suitably use the nonaqueous electrolyte secondary battery in accordance with an embodiment of the present invention as a battery for, for example, a personal computer, a mobile telephone, a portable information terminal, and a vehicle.

1. A nonaqueous electrolyte secondary battery comprising:
a nonaqueous electrolyte secondary battery separator having ion permeability barrier energy of not less than 300 J/mol/μm and not more than 900 J/mol/μm per unit film thickness;
a positive electrode plate having a capacitance of not less than 1 nF and not more than 1000 nF per measurement area of 900 mm²; and
a negative electrode plate having a capacitance of not less than 4 nF and not more than 8500 nF per measurement area of 900 mm².

2. The nonaqueous electrolyte secondary battery as set forth in claim 1, wherein the positive electrode plate contains a transition metal oxide.

3. The nonaqueous electrolyte secondary battery as set forth in claim 1, wherein the negative electrode plate contains graphite.
